(19) United States
(12) Patent Application Publication
(10) Pub. No.: US 2006/0068752 A1
(43) Pub. Date: Mar. 30, 2006

(54) Method and apparatus for providing an alarm notification by a dispatch call

(75) Inventors: Yonghao Lin, Lake in the Hills, IL (US); Sreepad Gopalarao, Rolling Meadows, IL (US); Peter P. Hux, Downers Grove, IL (US); Barry M. Kogan, Arlington Heights, IL (US); Carl J. Kraco, Carol Stream, IL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 10/955,085

(22) Filed: Sep. 30, 2004

(51) Int. Cl. H04M 11/04

(52) U.S. Cl. 455/404.1

(57) ABSTRACT

A first server (103) includes an alarm interface, receiving alarm notifications (117, 119) from alarm generating equipment (101); a communication interface, transmitting/receiving communications via a communication network (105); and a processor. The processor can receive alarm notification(s) via the alarm interface; convert the alarm notification(s) to alarm information; determine recipient(s) corresponding to the alarm notification(s); and, responsive to receipt of the alarm notification(s), transmit communication(s), associated with dispatch call information and alarm information, over the network (105) to the recipient (113, 115). A second server (107) includes a first communication interface, transmitting/receiving communications via the communication network (105); a second communication interface, transmitting/receiving communications via a dispatch network (109); and a processor. The processor can receive the communication, e.g., a dispatch call request via the first communication interface; transform the at least one dispatch call request into a dispatch call; and transmit the dispatch call via the second communication interface.

### FIELD OF THE INVENTION

The present invention relates in general to wireless communication units and wireless networks, and more specifically to providing alarm notifications via a wireless network to a wireless communication unit.

### BACKGROUND OF THE INVENTION

Certain equipment can be provided with a capability of generating alarms, relating for example to devices being monitored, generating alarms themselves, and/or to the equipment itself. For example, when equipment installed at an industrial site goes out of service, experiences a malfunction, or encounters certain conditions, the equipment can generate an alarm. Alarms are typically delivered, for example, from a console connected to one or more alarm generating devices. When personnel monitoring the alarms are positioned in the vicinity of the control system console, the personnel can adequately handle the alarms, and can rapidly receive information regarding the alarms. Hence, they can receive immediate notification about, for example, emergency situations.

When personnel is located remotely from the control system console, such as could happen when for example personnel are in the field or located at a distance from the console, personnel still desire rapid notification of alarm conditions. Even when personnel are located in the same area, alarming can be difficult due to noise levels.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages in accordance with the present invention.

FIG. 1 is a diagram illustrating a simplified and representative environment associated with automatic generation of alarm notification to communication unit and exemplary networks in accordance with various exemplary embodiments;

FIG. 2 is a diagram illustrating an exemplary first server arranged for processing alarms in accordance with various exemplary embodiments;

FIG. 3 is a block diagram illustrating portions of an exemplary second server arranged for processing dispatch network/computer network communications in accordance with various exemplary embodiments;

FIG. 4 is a flow diagram illustrating communications in an exemplary computer network and dispatch network environment in accordance with various exemplary embodiments;

FIG. 5 is a flow chart illustrating exemplary alarm processing in accordance with various exemplary and alternative exemplary embodiments; and

FIG. 6 is a flow chart illustrating exemplary computer/dispatch processing in accordance with various exemplary and alternative exemplary embodiments.

### DETAILED DESCRIPTION

In overview, the present disclosure concerns wireless communications devices or units, often referred to as communication units, such as cellular phones or two-way radios and the like having the operating capability for conveying communications, and the communication systems associated therewith, such as an Enterprise Network, a cellular Radio Access Network, or the like. Such communication systems may further provide services such as voice and data communications services. More particularly, various inventive concepts and principles are embodied in systems, communication units, and methods therein for communicating alarm notifications to a communication unit. It should be noted that the term communication unit might be used interchangeably herein with subscriber unit, wireless subscriber unit, wireless subscriber device or the like. Each of these terms denotes a device ordinarily associated with a user and typically a wireless mobile device that may be used with a public network, for example in accordance with a service agreement, or within a private network such as an enterprise network or a dispatch network. Examples of such units include personal digital assistants, personal assignment pads, and personal computers equipped for wireless operation, a cellular handset or device, or equivalents thereof provided such units are arranged and constructed for operation in appropriate networks.

The communication systems and communication units of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore the wireless communication units or devices of interest can have short range wireless communications capability normally referred to as WLAN (wireless local area network) capabilities, such as IEEE 802.11, Bluetooth, or Hiper-Lan and the like preferably using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication units or devices of interest may be connected to a LAN using protocols such as TCP/IP, UDP/UP, IPX/SPX, or Net BIOS via a hardwired interface such as a cable and/or a connector. More particularly, the wireless communication units or devices of interest can have a dispatch communication capability.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. The invention may include processes and/or steps, which can be performed in any order, unless expressly and necessarily limited to a particular order; thus processes or steps that are not so limited may be performed in any order.

Much of the inventive functionality and many of the inventive principles when implemented, are best supported with or in software or integrated circuits (ICs), such as a digital signal processor and software therefore or application specific ICs. The processor can be, for example, a general purpose computer, can be a specially programmed special purpose computer, can include a distributed computer system, and/or can include embedded systems. Similarly, the processing could be controlled by software instructions on one or more computer systems or processors, or could be partially or wholly implemented in hardware. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

As further discussed herein below, various inventive principles and combinations thereof are advantageously employed to improve automatic notification of an alarm via a communication network.

Further in accordance with exemplary embodiments, a first server connects to certain devices, such as sensors, that can generate alarms. When the sensor needs to report an alarm, the alarm generator receives the sensed information and transmits the alarm to the first server. The first server transforms the alarm and associated information to, for example, voice information appropriate for use on a dispatch network, and makes a dispatch call request to a second server. The second server sends the requested dispatch call to the communication device. Based on, for example, alarm severity or other parameters, notifications can be sent to particular personnel or groups of users, and/or notifications can be escalated based on responses.

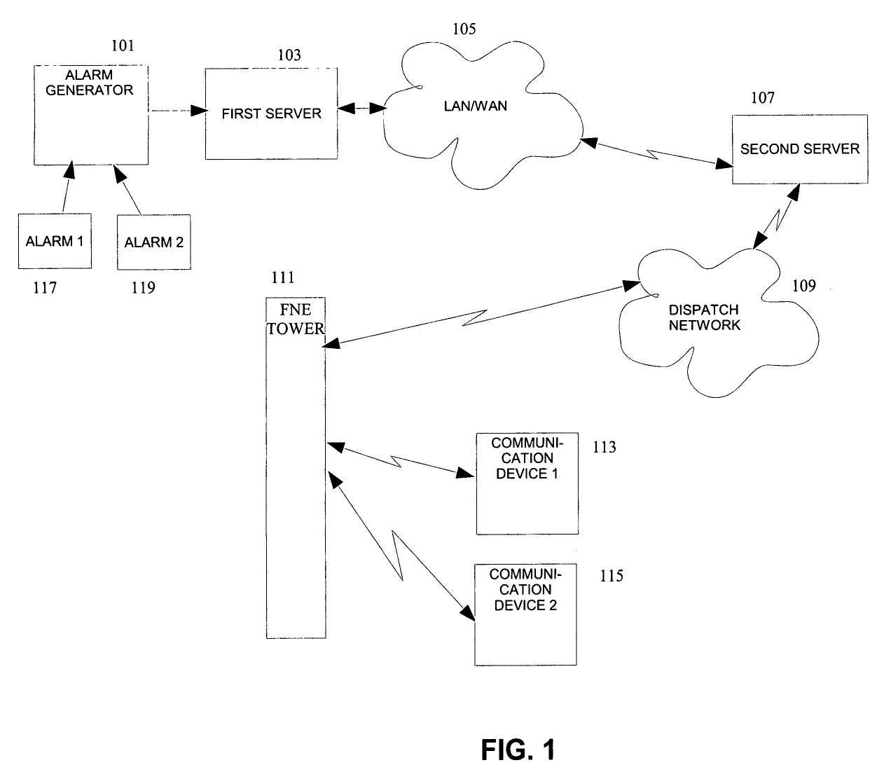

Referring now to FIG. 1, methods and devices for automatically generating an alarm notification to a communication unit will be discussed and described. FIG. 1 is a diagram illustrating a simplified and representative environment associated with automatic generation of alarm notification to communication units and exemplary networks in accordance with various exemplary embodiments. The illustrated example provides an alarm generator 101 that receives one or more alarm indication or alarms, e.g., alarm 1 117 and alarm 2 119. The alarm generator 101 transmits an alarm notification to a first server 103. The first server 103 transforms the alarm notification to alarm information, for example, voice information appropriate for use on a dispatch network, and makes a dispatch call request via a communication network, e.g., a LAN/WAN network 105, to a second server 107. The second server transforms the dispatch call request to a format appropriate for a dispatch call, and sends the requested dispatch call to the communication devices, e.g., communication device 1 113 and communication device 2 115, via a dispatch network 109. The dispatch network 109 transmits the dispatch call in accordance with its usual procedures, which can include for example the fixed network equipment (FNE), represented in FIG. 1 by an FNE tower 111. The dispatch call with the information associated with the alarm is received by one or more of the communication devices, e.g., communication device 1 113 and/or communication device 2 115.

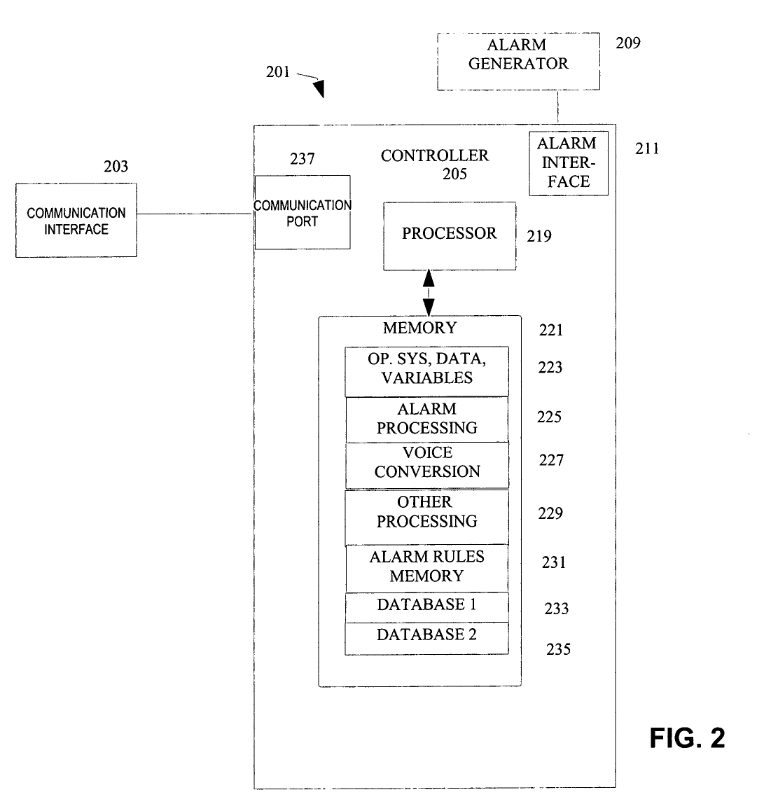

In accordance with one or more embodiments, the first server 103 can include, for example, an alarm interface (illustrated in FIG. 2), for receiving alarm notifications when connected to alarm generating equipment. Alarm notifications can be provided in accordance with standards determined by the equipment. For example, an alarm 1 117 associated with a particular device will be provided with information in a particular format. The information provided in connection with the alarm can be specific to a particular type of equipment. A variety of alarm formats are known and supported in the industry.

“Alarm generating equipment,” as used herein, is intended to refer to a wide variety of equipment that monitor device(s), including itself, and/or can receive alarm signals, and can generate a signal intended to advise of various device and/or environment and/or timing conditions and/or danger and/or a combination of the foregoing. An alarm can be generated electronically, mechanically, or electrically by the devices, and/or can be generated by the alarm generating equipment based on one or more alarms. Alarm generating equipment optionally generates an audible message or alert. Information regarding alarms optionally can be provided as text and/or images via a display in communication with the alarm generating equipment. Current technology typically provides that the alarm generating equipment transmits the alarm notification in a text format, although it is anticipated that alternative formats can be available and can be accommodated.

The first server 103 can receive the alarm notifications, for example via an alarm interface (illustrated in connection with FIG. 2). Known equipment is available to provide an interface between the alarm generating equipment and a processor, suitable for receiving the alarm notification provided by the alarm generating equipment.

In accordance with one or more embodiments, the first server 103 can include a communication interface (illustrated in connection with FIG. 2), for transmitting and receiving standard communications over a computer network when connected.

Further, according to one or more exemplary and alternative exemplary embodiments, the first server 103 can include a processor (illustrated in connection with FIG. 2), which can advantageously be configured to facilitate providing processing associated with the first server 103. The first server 103 can be configured to facilitate receiving one or more alarm notifications via the alarm interface.

Further, the first server 103 can be configured to facilitate transforming the alarm notification to alarm information appropriate for being provided via a dispatch call, which can advantageously include audible signals and/or other information. For example, the alarm information can include text; the alarm notification can be converted from text to speech, e.g., in accordance with known techniques, and included as alarm information; the alarm notification can be associated with one or more pre-recorded text or audible notifications, e.g., as a recorded voice file in PCM (pulse code modulation) format, which is included in the alarm information; and/or can be a combination of the foregoing. According to one or more exemplary embodiments, the alarm notification can be converted and transmitted in the alarm information in a voice format for voice communication packets such as VSELP (vector sum excited linear prediction). In accordance with exemplary and alternative exemplary embodiments, the alarm information can be associated with other information, e.g., haptic, text and/or image data.

The server 103 can facilitate determining one or more recipients corresponding to one or more alarm notifications. It is anticipated that a server can be configured by a user to associate alarm notifications or data provided in alarm notifications, for example, types of equipment and/or types of alarms, or combinations thereof, with personnel. This can be provided, for example, in a database and/or a look-up table or other appropriate methods and devices. Such information can further include dispatch call information for use in facilitating the receipt of a dispatch call by the personnel, e.g., dispatch identification.

In accordance with one or more embodiments, the server 103 provides, in response to receipt of one or more alarm notifications, for transmitting one or more communications, in association with dispatch call information and alarm information, over the network to the recipient(s) of the communication(s). In accordance with one or more exemplary and alternative exemplary embodiments, the network can be, for example, the LAN/WAN network 105. In this situation, the first server 103 can be connected indirectly with the dispatch network 109 via the LAN/WAN network 105.

In accordance with one or more exemplary alternative embodiments, the first server 103 can be in more direct communication with the dispatch network 109. For example, if the first server includes a capability of communicating with the dispatch network 109, the communication can further be formed to be appropriate for transmission to a dispatch network, in order to generate one or more dispatch calls to the recipient(s)

In accordance with one or more embodiments and alternative embodiments, the first server 103 can associate the dispatch call information with an indication that the communication should be provided as a private call, a group call, a call alert, and/or an instant text message. Dispatch call information can be used in formatting the dispatch call requested that is transmitted to the dispatch network 109.

One or more embodiments provide that the first server 103 determines one or more recipients of a dispatch call including the alarm information in response to a priority of the alarm notification. An alarm notification can be associated with an indication of the priority of the alarm. It may be desirable to associate particular levels of alarm priority with particular personnel. This can be provided, for example, in a database and/or a look-up table or other appropriate methods and devices.

The first server 103 of one or more embodiments can be configured to facilitate simulating at least one subscriber of a dispatch call. For example, the communication that is ultimately transmitted to the dispatch network 109 can include subscriber information (for the first server) that corresponds to a permitted subscriber on the dispatch network, formatted in accordance with dispatch network specifications. If appropriate, the first server 103 can be configured to facilitate setting up other information necessary to simulate a subscriber, e.g., information provided via external tables.

In accordance with one or more exemplary alternative embodiments, the server 103 can provide for escalating a communication to a next level of authority in certain situations. For example, when one or more recipient(s) of a communication is determined to be non-responsive or has failed to respond in a pre-determined amount of time, or when an alarm is determined to be non-responsive to efforts to resolve, it may be desirable to provide for alternative personnel to be contacted in connection with the alarm information. For example, a communication to particular personnel can be determined to be successful by receipt of a return communication, or a communication (e.g., a dispatch call) received from the personnel. As another example, it may be desirable to escalate to other personnel when a next alarm notification is a part of a series of alarm notifications, and together indicate that the communication should be escalated to different personnel or group of personnel. Data utilized in determining escalation of communications, alarm notifications, personnel, and/or timing thereof can be advantageously stored as information and/or in a rules database.

One or more exemplary embodiments and alternative exemplary embodiments provide that the server 103 can receive a response from one or more recipients of communications. The response can include dispatch call information from the recipient, e.g., the dispatch caller identity and/or personnel information associated therewith, and/or content of the dispatch call, e.g., voice. Optionally, the server 103 can record and store such responses, for example for later review, search, retrieval, and or study.

The servers as described herein can store collected information in a database. A database can be located on local internal drives, local external drives, network attached storage (NAS), a storage area network (SAN), etc. The various databases may be in, for example, a UNIX format, but other standard or special purpose data formats may be used. The database optionally is distributed and/or networked.

In accordance with one or more embodiments, it may be desirable for the first server 103 to provide storage of rules establishing one or more first recipients corresponding to the alarm notification and/or the priority of the alarm notification. Moreover, the rules can establish one or more second recipients corresponding to the one alarm notification and a time delay to be applied, for example prior to contacting the second recipient.

The first server 103 can be configured more particularly to provide a dispatch call setup request prior to transmitting the dispatch call request, and to transmit a dispatch call termination request, subsequent to transmitting the dispatch call request. The dispatch call setup request, the dispatch call request and/or the dispatch call termination request can be transmitted over the communication network 105.

In accordance with one or more embodiments, the recipient or group or recipients that are to receive an alarm notification can be determined dynamically by the first server 103. For example, the recipients available for receipt of alarm notifications can be determined based on time of day, day of week, work schedule, vacation schedule, etc. As another example, the recipients for alarm notifications can be determined based on whether the recipient has already received a maximum number of alarm notifications. As a further example, recipients can be determined dynamically by grouping recipients by location of alarm notifications, whereby recipients can more readily physically check co-located alarm notifications.

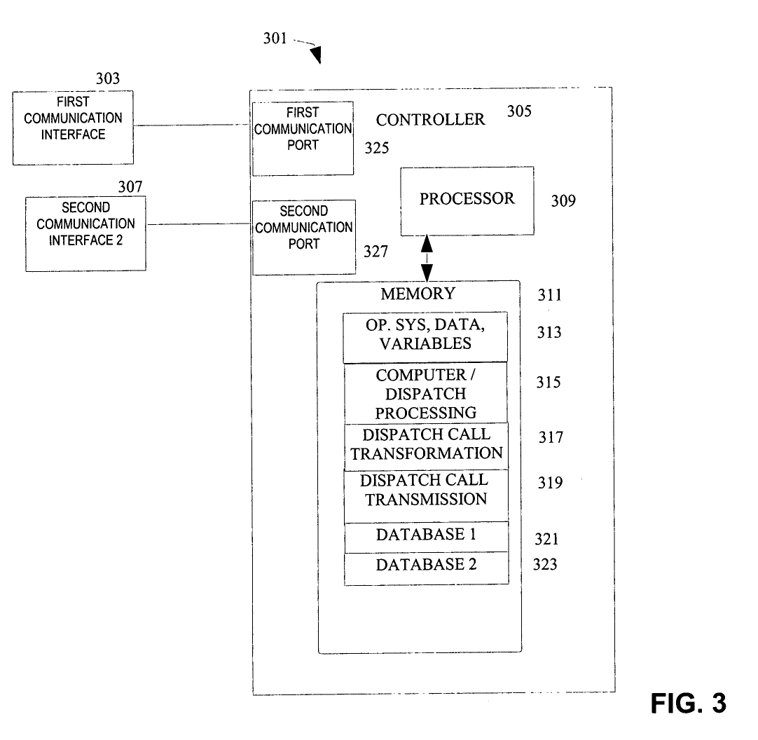

In accordance with one or more embodiments, the second server 107 can include a first communication interface (illustrated in FIG. 3), for transmitting and receiving communications when operably connected to a computer network 105; and a second communication interface (also illustrated in FIG. 3), for transmitting and receiving communications when operably connected to a dispatch network 109. The second server 107 advantageously can include a processor (also illustrated in FIG. 3), wherein the processor is configured to facilitate various operations and procedures described herein.

The second server 107, for example operating in response to the first server 103, can be configured to transform a dispatch call request appropriate for communication over a computer network, e.g., the LAN/WAN network 105, into a dispatch call appropriate for transmission over the dispatch network 109. In accordance with one or more embodiments, the second server 107 receives one or more dispatch call requests via the first communication interface. The second server 107 also transmits a dispatch call over the dispatch network 109 via the second communication interface.

The second server 107 can be configured to transform the dispatch call requests it receives into dispatch calls that can be recognized by the dispatch network 109. The dispatch call request may include information necessary and/or desirable for formatting a dispatch call, and includes content to be included in the dispatch call. The dispatch call request may include, as discussed previously, for example, dispatch call information and alarm information, to assist in formation of the dispatch call to the desired recipients. Dispatch call information may include, for example, subscriber information to indicate or simulate the originator of the call (e.g., the first server 103). Utilizing the dispatch call information, the second server 107 prepares a dispatch call in accordance with known formats therefore, and transmits the dispatch call to the dispatch network 109.

The dispatch call can be, for example, a private call, a group call, a call alert, and/or an instant text message. An indicator can be included in the dispatch call request corresponding to the type of dispatch call.

The second server 107 can be configured to provide the dispatch call so that it appears to be a normal dispatch call to the dispatch network 109. For example, the second server 107 can be configured in accordance with known techniques to simulate a cell site with respect to the dispatch network 109. Further, the second server 107 can simulate the type of dispatch call, corresponding to the indicator in the dispatch call request. For example, where the type of dispatch call is a group call, the second server 107 can cause the call to appear to be a group call, thereby causing the dispatch network 109 to utilize its known techniques of duplication and parallel signal distribution, e.g., on the same time slot, to the recipients in the group.

According to one or more exemplary embodiments and alternative exemplary embodiments, the recipient can call back to notify the system that the alarm notification has been handled. For example, the second server 107 can receive a dispatch call from one of the communication devices 113, 115 via the dispatch network 109; can transform the dispatch call into a communication for a computer network communication by applying principles discussed previously; and can transmit the communication to the first server 103 via the computer network, e.g., the LAN/WAN network 105.

In accordance with one or more embodiments, the second server 107 can be further configured to facilitate transmitting and/or receiving calls over the dispatch network in accordance with the expected procedures. For example, the second server 107 can be configured more particularly to receive a dispatch call setup request over the communication network, e.g., the LAN/WAN network 105, and in response, to transmit a dispatch call setup request to the dispatch network 109. Moreover, the second server 107 can be configured to transmit a dispatch call termination to the dispatch network 109 in response to receipt of a dispatch call termination request.

Referring now to FIG. 2, one or more exemplary embodiments and alternative exemplary embodiments of the first server will be discussed and described. FIG. 2 is a diagram illustrating an exemplary first server 201 arranged for processing alarms in accordance with various exemplary embodiments.

The controller 205 may include a communication interface 203, e.g., to connect to a communication network (not illustrated), a communication port 237 for communicating via the communication interface 203, a processor 219, a memory 221, and an alarm interface 211 to be connected to an alarm generator 209.

The processor 219 may comprise one or more microprocessors and/or one or more digital signal processors. The memory 221 is coupled to the processor 219 and may comprise a read-only memory (ROM), a random-access memory (RAM), a programmable ROM (PROM), an electrically erasable read-only memory (EEPROM) and/or magnetic memory or the like. The memory 221 may include multiple memory locations for storing, inter alia, an operating system, data and variables 223 for programs executed by the processor 219; computer programs for causing the processor to operate in connection with various functions such as alarm processing 225, voice conversion 227, and/or other processing 229; an optional memory 231 of various alarm rules; and other databases 233, 235 for other information used by the processor 219. The computer programs may be stored, for example, in ROM, PROM, etc. and may direct the processor 219 in controlling the operation of the first server 201.

Responsive to an alarm notification via the alarm interface 211, in accordance with instructions stored in memory 221, or automatically upon receipt of certain information via the communication interface 203, the processor 219 may process the alarm notification or received information, such as a communication from the communication network.

Referring now to FIG. 3, one or more exemplary embodiments and alternative exemplary embodiments of the second server 301 will be discussed and described. FIG. 3 is a block diagram illustrating portions of an exemplary second server arranged for processing dispatch network/computer network communications in accordance with various exemplary embodiments.

The second server 301 can include a controller 305. The controller 305 may include a first communication interface 303, e.g., to connect to a communication network (not illustrated), a first communication port 325 for communicating with the first communication interface 303, a second communication interface 307, e.g., to connect to a dispatch network (not illustrated), a second communication port 327 for communicating with the second communication interface 307, a processor 309, and a memory 311.

The processor 309 may comprise one or more microprocessors and/or one or more digital signal processors. The memory 311 may be coupled to the processor 309 and may comprise one or more of a read-only memory (ROM), a random-access memory (RAM), a programmable ROM (PROM), an electrically erasable read-only memory (EEPROM) and/or magnetic memory or the like. The memory 311 may include multiple memory locations for storing, inter alia, an operating system, data and variables 313 for programs executed by the processor 309; computer programs for causing the processor to operate in connection with various functions such as processing communications for dispatch over the computer network and/or the dispatch network 315, dispatch call transformation 317, dispatch call transmission 319, and/or other processing (not illustrated); and databases 321, 323, for other information used by the processor 309. The computer programs may be stored, for example, ROM, PROM, etc. and may direct the processor 309 in controlling the operation of the second server 301.

Responsive to receipt of a communication or signaling via the first communication interface 303, in accordance with instructions stored in memory 311, or automatically upon receipt of a communication or signaling via the second communication interface 307, the processor 309 may process the received communication or signaling, such as described herein in more detail.

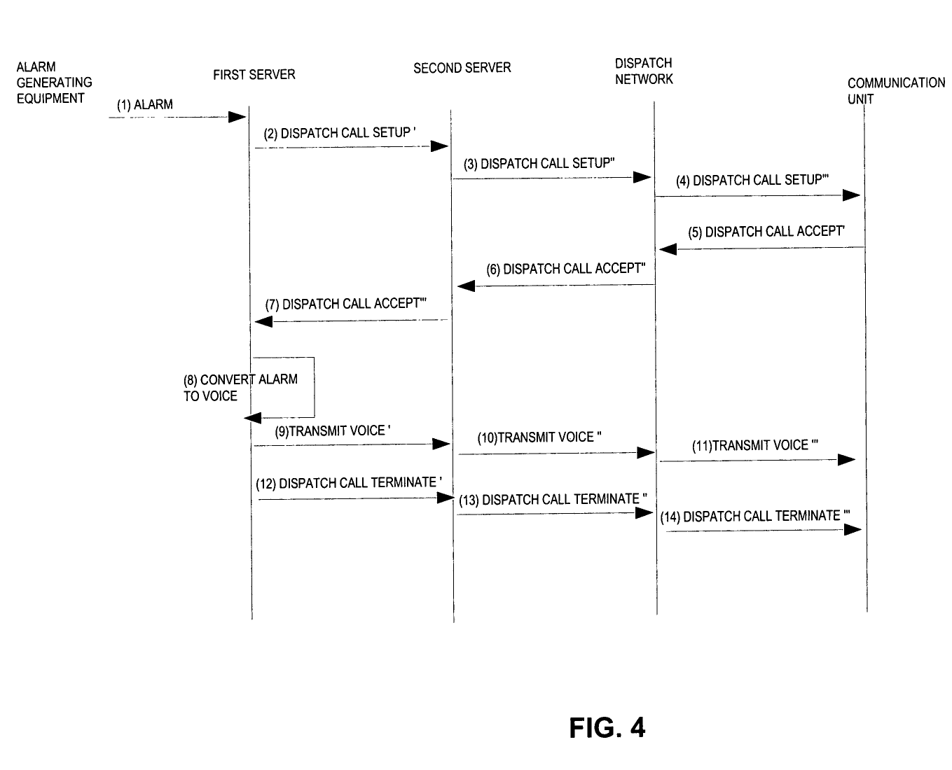

Referring now to FIG. 4, a communication flow in accordance with one or more exemplary embodiments and alternative exemplary embodiments will be discussed and described. FIG. 4 is a latter diagram or flow diagram illustrating communications in an exemplary computer network and dispatch network environment in accordance with various exemplary embodiments.

In accordance with one or more exemplary and alternative exemplary embodiments, the alarm generating equipment transmits an alarm 1. In response, the first server transmits a dispatch call setup′ 2 to the second server. The second server, upon receipt of the dispatch call setup′ 2, transmits a dispatch call setup″ 3 to the dispatch network. The dispatch network then transmits a dispatch call setup′″ 4 to the communication unit.

According to known techniques, the communication unit then transmits a dispatch call accept′ 5 to the dispatch network. Responsive thereto, and in accordance with conventional methods, the dispatch network transmits a dispatch call accept″ 6 to the second server, which as described above simulates an originating subscriber. In response, the second server transmits a dispatch call accept′″ 7 to the first server.

Having had the dispatch call accepted, the first server can complete preparation of the alarm information in the communication to be sent to the communication unit. The present illustration provides, in accordance with one or more embodiments, that the alarm information is provided to the communication unit as a standard voice dispatch call. For example, as illustrated, the first server can convert text included in the alarm notification to voice information 8 to be included in the alarm information associated with the communication.

The first server can transmit the communication, in this example by transmitting voice communication′ 9, to the second server, e.g., over a LAN/WAN communication network. Upon receipt thereof, the second server can transmit the exemplary voice communication″ 10 to the dispatch network. Utilizing known techniques, the dispatch network can transmit the exemplary voice communication′″ 11 to the communication unit. The communication unit can provide the voice information to the recipient as audio in accordance with the usual processing.

In order to provide the dispatch call terminate that can be expected by the communication unit, the first server can transmit a dispatch call terminate′ 12 via the communication network to the second server. The second server, responsive thereto, can transmit a dispatch call terminate″ 13 via the dispatch network. In response to receipt of the dispatch call terminate″, the dispatch network transmits a dispatch call terminate′″ 14 to the communication unit, thereby terminating the dispatch call.

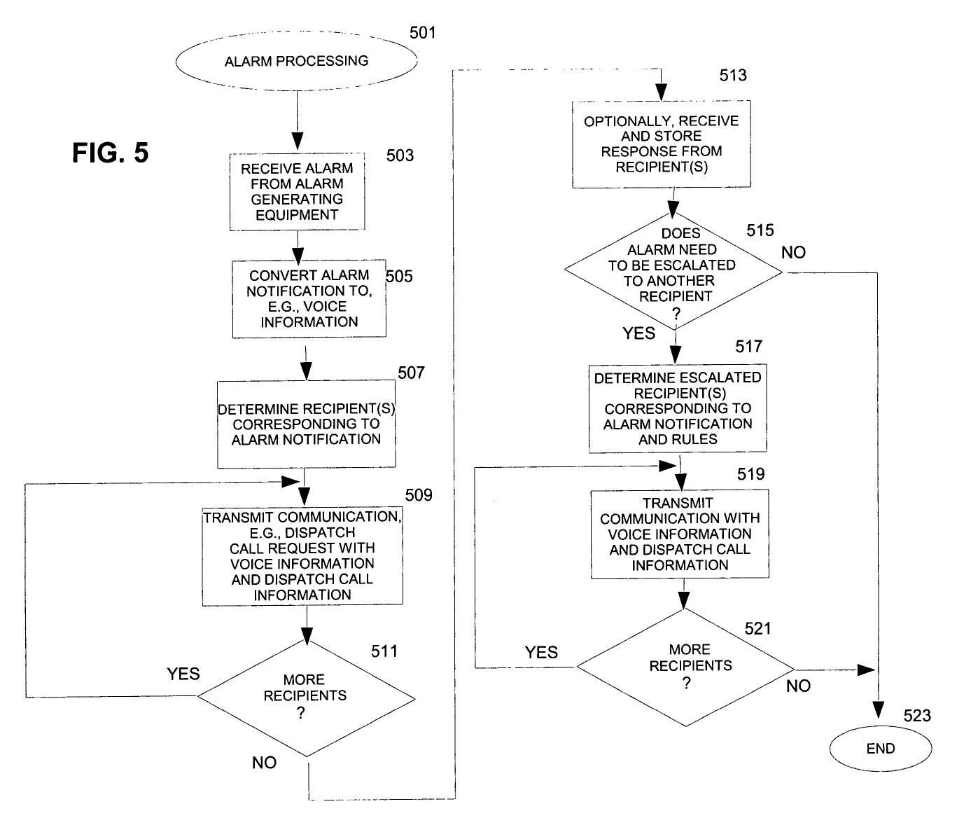

Referring now to FIG. 5, a process for processing alarms according to one or more exemplary embodiments and alternative exemplary embodiments will be discussed and described. FIG. 5 is a flow chart illustrating exemplary alarm processing 501 in accordance with various exemplary and alternative exemplary embodiments. The processing described in connection with FIG. 5 can advantageously be implemented in connection with the processor of the first server described above, for example, in connection with FIG. 2, or other appropriately configured apparatus and systems.

The processing provides for receiving 503 an alarm notification from, for example, the alarm generating equipment, as described previously in detail. The processing converts 505 the alarm notification into, for example, voice information or other information to be included in the communication, which will ultimately be received by the communication unit, as previously described in detail.

In accordance with one or more embodiments, the processing determines 507 one or more recipients that correspond to the alarm or other information included in the alarm notification. Various exemplary and alternative exemplary embodiments for determining appropriate recipients have been previously discussed herein. Moreover, the process can determine dispatch call information corresponding to the recipients, as described above.

Further, in accordance with one or more embodiments, the processing provides for transmitting 509 a dispatch call request with, e.g., the voice information (and/or other information) and dispatch call information. The process can determine whether there are more recipients 511 of the dispatch call request. If so, the process loops back to further transmit 509 the dispatch call request to the additional recipient(s).

In accordance with one or more exemplary and alternative exemplary embodiments, the process optionally 513 receives and stores responses from the recipient(s). Various exemplary embodiments providing for the receipt of responses have been described above.

Further, in accordance with one or more embodiments, the processing provides for determining whether the alarm 515 needs to be escalated to another recipient. Various exemplary and alternative exemplary embodiments providing for escalation have been previously described herein.

If escalation is indicated, then the processing determines 517 one or more escalated recipient(s) corresponding to the alarm and optional rules, as previously described herein in detail. Further, the processing provides for transmitting 519 the communication, for example with the voice information and dispatch call information or other information regarding alarm status, response status, or the like, so that it will be dispatched to the escalated recipients. The process can determine whether there are more recipients 521 of the communication. If so, the process loops back to further transmit 519 the communication to the additional recipient(s).

Processing then ends 523, however the process may be repeated as required or needed.

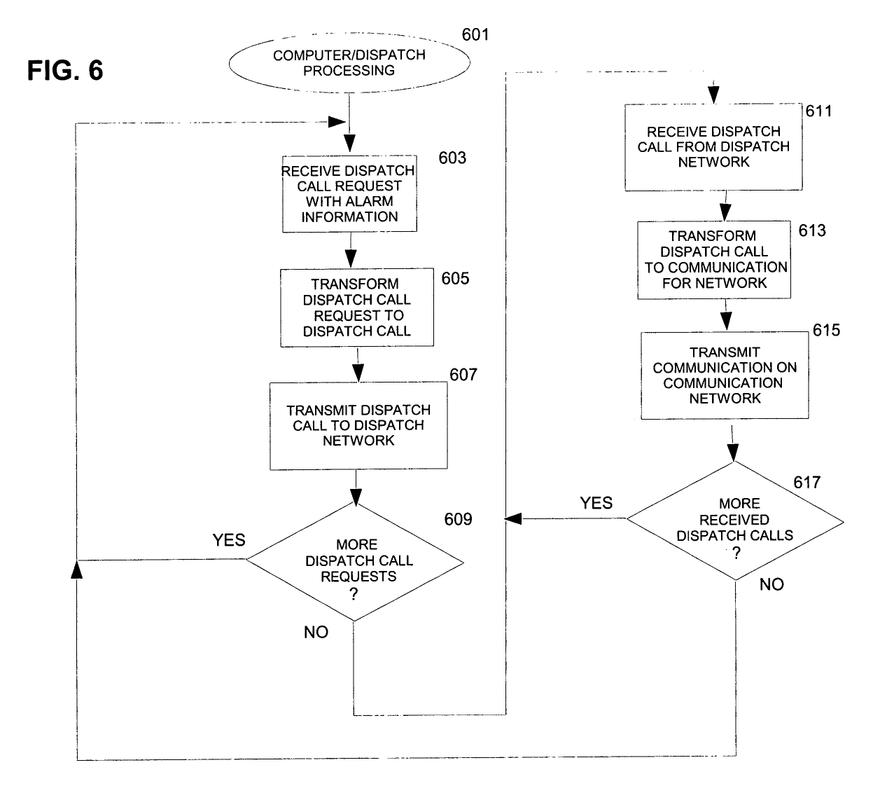

Referring now to FIG. 6, a process for processing dispatch call requests associated with alarm processing according to one or more exemplary embodiments and alternative exemplary embodiments will be discussed and described. FIG. 6 is a flow chart illustrating exemplary computer/dispatch processing 601 in accordance with various exemplary and alternative exemplary embodiments. The processing described in connection with FIG. 6 can advantageously be implemented in connection with the processor of the second server described above, for example, in connection with FIG. 3, or other apparatus and system with similar or appropriate functionality.

The processing provides for receiving 603 a dispatch call request with alarm information. The received dispatch call request is transformed 605 to a dispatch call. Various exemplary and alternative exemplary procedures for performing such transformation have been previously described herein.

The processing provides that the dispatch call request, having been transformed, is transmitted 607 to the dispatch network, as previously described herein. Processing checks whether there are more 609 dispatch call requests, and if so, proceeds to receive 603 the next dispatch call request as described above.

In accordance with one or more embodiments, the processing provides for receiving 611 a dispatch call from the dispatch network, transforming 613 the dispatch call to a communication appropriate for the communication network, and transmitting 615 the communication on the communication network. Exemplary and alternative exemplary embodiments providing details illustrating examples of the foregoing have been previously provided. The processing can check whether there are more 617 received dispatch calls from the dispatch network, and if so, loop to receive the dispatch call 611, as described above.

The processing can proceed, e.g. repeat, to check for further received 603 dispatch call requests.

As previously discussed, in accordance with one or more exemplary embodiments and alternative exemplary embodiments, functions of the first server and the second server can be combined into a single server or a distributed server, if preferred. Hence, for example, the communication provided by the first server may be formatted as a dispatch call request that can be handled by a conventional dispatch network.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A server comprising:
an alarm interface, for receiving alarm notifications when connected to alarm generating equipment;
a communication interface, for transmitting and receiving communications when operably connected to a communication network;
a processor, wherein the processor is configured to facilitate receiving at least one alarm notification via the alarm interface; to facilitate converting the at least one alarm notification to an alarm information; to facilitate determining at least one recipient corresponding to the at least one alarm notification; and to facilitate, responsive to receipt of the at least one alarm notification, transmitting at least one communication associated with dispatch call information and alarm information over the communication network to the at least one recipient.

2. The server of claim 1, wherein the dispatch call information provides for a dispatch call as one or more of: a private call, a group call, a call alert, and an instant text message.

3. The server of claim 1, wherein the at least one recipient is determined responsive to a priority of the alarm notification.

4. The server of claim 1, wherein the processor is further configured to facilitate simulating at least one subscriber unit corresponding to a dispatch call.

5. The server of claim 1, wherein the processor is further configured to facilitate escalating a communication to a next level of authority when the at least one recipient is determined to be non-responsive.

6. The server of claim 1, wherein the processor is further configured to facilitate receiving at least one response, from the at least one recipient, responsive to the at least one communication.

7. The server of claim 6, wherein the response includes dispatch call information from the recipient.

8. The server of claim 6, wherein the processor is further configured to facilitate storing the at least one response, for later review.

9. The server of claim 1, further comprising storage including a plurality of rules establishing at least a first recipient corresponding to at least one of the at least one alarm notification and a priority of the at least one alarm notification, and at least one second recipient corresponding to the at least one alarm notification and at least one time delay therefore.

10. The server of claim 1, wherein the processor is further configured to facilitate transmitting a dispatch call setup request via the communication network, prior to transmitting the at least one communication.

11. The server of claim 1, wherein the processor is further configured to facilitate transmitting a dispatch call termination request via the communication network, subsequent to transmitting the at least one communication.

12. The server of claim 1, wherein the processor is further configured to facilitate dynamically determining at least one group of recipients, including the at least one recipient.

13. The server of claim 1, wherein the processor is utilized in connection with alarm generating equipment.

14. The server of claim 1, wherein the processor is further configured to simulate at least one subscriber unit that is further configured as the originator of the at least one communication.

15. A server comprising:
a first communication interface, for transmitting and receiving communications when operably connected to a communication network;
a second communication interface, for transmitting and receiving communications when operably connected to a dispatch network; and
a processor, wherein the processor is configured to facilitate receiving at least one dispatch call request via the first communication interface; for transforming the at least one dispatch call request into a dispatch call; and for transmitting the dispatch call via the second communication interface.

16. The server of claim 15, wherein the dispatch call is one or more of: a private call, a group call, a call alert, and an instant text message.

17. The server of claim 15, wherein the processor is further configured to simulate a cell site with respect to the dispatch network.

18. The server of claim 15, wherein the processor is further configured to receive a second dispatch call; for transforming the second dispatch call to a communication for a communication network communication; and for transmitting the communication via the communication network.

19. The server of claim 15, wherein the processor is further configured to facilitate receiving a first dispatch call setup request via the communication network, and responsive to receipt thereof, to transmit a second dispatch call setup request via the dispatch network.

20. The server of claim 15, wherein the processor is further configured to facilitate receiving a first dispatch call terminate request via the communication network, and responsive to receipt thereof, to transmit a second dispatch call terminate request via the dispatch network.
